(19) United States
(12) Patent Application Publication
(10) Pub. No.: US 2005/0058795 A1
(43) Pub. Date: Mar. 17, 2005

(54) Vinyl ester hose and method for manufacture of such hose

(76) Inventors: Harold D. Beck, Strafford, MO (US); James C. Thacker, Ocala, FL (US)

Correspondence Address: DAYCO PRODUCTS, LLC, 1 PRESTIGE PLACE, MIAMISBURG, OH, 45342, US

(21) Appl. No.: 10/663,324

(22) Filed: Sep. 15, 2003

(51) Int. Cl. B32B 1/08

(52) U.S. Cl. 428/36.9

(57) ABSTRACT

A vulcanized tubular structure for conveying fluids in an automotive engine cooler, transmission oil cooler, power transmission cooler, radiator or heater; and a method for preparing the tubular structure are described. The tubular structure includes a single layer of a heat tolerant, pressure resistant, hydrocarbon fluid impermeable composition comprising a copolymer containing at least one vinyl ester having incorporated therein one or more additives. Preferably the copolymer is an ethylene-vinyl acetate copolymer.

### BACKGROUND OF THE INVENTION

The present invention relates to polymeric compositions and particularly to polymeric compositions which are useful in the manufacture of tubular structures. The polymeric compositions are especially useful in the manufacture of hoses for conveying fluids in an automotive engine cooler, a transmission oil cooler, power steering cooler, radiator or heater.

Hoses, particularly rubber hoses, are used in a variety of applications in the automotive industry as fuel feed hoses, torque converter hoses, power steering hoses and air conditioner hoses; as well as for industrial and household utility applications such as hydraulic hoses, refrigerator hoses, washing machine hoses, propane gas feed hoses, high pressure air hoses, garden hoses, etc.

It is generally known that rubber surfaces do not always exhibit desired resistance against chemical loads such as organic gases and solvents. Therefore, other approaches for improving the organic gas and solvent resistance of rubber materials included using rubber materials which have a different polarity than the organic gas or solvent, increase the crosslinking of the rubber material, adding or increasing certain additives, and increasing the wall thickness of the rubber tube material. All of these approaches have a down side. For example, the use of a rubber material having a polarity different from the organic gas or solvent requires the use of expensive rubber materials such as chloroprene rubber, acrylic rubber, epichlorhydrin rubber, and the like; increasing the degree of crosslinking of the rubber used detracts from the softness and flexibility of the rubber; the addition of additives affects the processability and certain physical properties of the rubber; and increasing the wall thickness of the rubber material also increases the weight of the structure. Generally, these undesirable effects overshadow any advantage gained in the improved gas and solvent resistance.

Other approaches employed to improve the impermeability of multi-layered rubber hoses includes the use of a metal film as a barrier layer coated on one of the inner layers. Such disclosures appear, for example, in U.S. Pat. No. 318,458 to Fletcher where there is disclosed a multi-layer tubular structure made from India rubber and having a tin foil liner. Other prior art patents such as U.S. Pat. Nos. 4,559,973 to Hane et al.; 4,758,455 to Campbell et al; 5,182,147 to Davis; 5,271,977 to Yoshikawa et al; 5,360,037 to Lindstrom; 5,398,729 to Spurgat; and 5,476,121 to Yoshikawa et al have attempted similar methods to reduce the permeability of fluids and/or gases through various tubes. Commonly assigned U.S. Pat. No. 6,074,717 to Little et al; and U.S. Pat. Nos. 4,779,673 and 5,488,975 to Chiles et al disclose metal coated synthetic rubber hoses used for circulation of fluids in radiant heating systems in houses and in businesses discloses the use of an inner nylon tubular layer having a metal layer surrounding the nylon layer.

Polymeric material used to form the hose for accommodating fluids and gases under elevated pressures and/or high temperatures such as in automotive air conditioners cooler hoses and power steering hoses must meet other critical requirements. For example, the polymeric material must exhibit low permeability to FREON or other coolant gases to prevent such gases from escaping from the hose. Also such polymeric hose must be able to prevent outside moisture from entering the interior of the hose where it could contaminate the fluid or gas. In addition the polymeric hose must be heat tolerant, able to withstand engine and impact vibration, and be capable of forming gas tight connections.

In the case of composite hoses for accommodating coolant fluid for automotive air conditioners, etc., polymeric materials such as polychloroprene (CR), acrylonitrile-butadiene rubber (NBR), chlorosulfonated polyethylene (CSM), chlorinated polyethylene (CPE), polyacrylate (PA), ethylene-acrylic elastomer (EAM), as well as nylon are often used as the material for forming the hose. For example, nylon 6 and nylon 66 are very low in coolant gas permeability, but are relatively high in moisture permeability. On the other hand, nylon 11 and nylon 12 are relatively low in moisture permeability and less susceptible to hydrolysis, but are moderately high in gas permeability. Blends of any of the various nylons with other nylons, olefins or other materials are also used in such applications. For example, blends such as nylon 6, nylon 4, nylon 66, nylon 11, nylon 12, have been made to take advantage of desirable characteristics of one or more of such nylons and, at the same time, reduce the effects of any undesirable characteristics.

Other materials, such as polymers, copolymers and blends thereof have been employed in the wire and cable industry as a sheath or cover material surrounding electrical wires. For example, polymeric blends of ethylene-vinyl acetate copolymers with ethylene-vinyl acetate-carbon monoxide terpolymers which are particularly useful in applications where flame retardant, low smoke, oil resistant, flexible systems are desirable as a wire coating. For example, blends of ethylene-vinyl acetate copolymers with ethylene-vinyl acetate-carbon monoxide terpolymers are described in U.S. Pat. No. 6,133,367 to Arhart for use in automotive wire and cable coating applications. Other patents disclosing the use of ethylene-vinyl acetate copolymers as wire and cable coatings include 4,349,605 to Biggs et al; 4,381,362 to Biggs et al; 4,477,523 to Biggs et al; 5,191,004 to Maringer et al; 5,225,469 to Maringer et al; and 5,256,489 to Maringer et al.

Ethylene-vinyl acetate copolymers (VAE) and blends of such ethylene-vinyl acetate copolymers are well known. For example, U.S. Pat. No. 4,338,227 describes various ethylene-vinyl acetate copolymers and the uses thereof. Copolymers of ethylene and vinyl acetate exhibit elastomeric characteristics and are commonly used to improve adhesion properties of hot melt, solvent-based and pressure-sensitive adhesives. It is generally well known that the use of ethylene-vinyl acetate copolymers in the automotive industry and commercial applications are mostly limited to coatings, adhesives, gaskets, O-rings and the like. For example, “Ultrathene”, a series of ethylene-vinyl acetate copolymers manufactured by Quantum Chemical, is typically used for adhesives, conversion coatings and thermoplastic modifiers. Such VAE copolymers exhibit a wide range of melt indexes. Ethylene-vinyl acetate copolymers are also marketed by Bayer under the trade name “Levapren”. These VAE copolymers are described as oil and heat resistant materials which may be used in air hose applications. However, there is no mention of such VAE polymers or copolymers as automotive tubular structures through which hydrocarbon fluids are transported under conditions of extreme heat and/or pressure.

Polymeric blends of ethylene-vinyl acetate copolymers with ethylene-vinyl acetate-carbon monoxide terpolymers which are particularly useful in applications where flame retardant, low smoke, oil resistant, flexible systems are desirable as a coating, for example, in wire and cable construction, are described in U.S. Pat. No. 6,133,367 to Arhart. Other patents disclosing the use of ethylene-vinyl acetate copolymers as wire and cable coatings include 4,349,605 to Biggs et al; 4,381,326 to Biggs et al; 4,477,523 to Biggs et al; 5,191,004 to Maringer et al; 5,225,460 to Maringer et al; and 5,226,489 to Maringer et al.

Choosing the right material or combination of materials to be used in the construction of automotive hoses is becoming more and more difficult because the hoses are now required to withstand higher pressures and temperatures than previous hoses performing the same tasks. Also mandated regulations require that the hoses exhibit greater impermeability rates and resist stress over longer periods of time while maintaining manufacturing costs at an acceptable level. Therefore, the manufacturer of automotive hoses finds it necessary to come up with newer and better materials and combinations of materials to meet these rising needs.

### SUMMARY OF THE INVENTION

It has now been discovered that certain copolymers of one or more vinyl esters such as a copolymer of an olefin and a vinyl ester or a copolymer of a first vinyl ester and a second vinyl ester has promise as a material for the manufacture of hoses useful in transporting various automotive fluids and gases, e.g., engine oil cooler fluids, transmission oil cooler fluids, power steering fluids, radiator fluids, heater fluids, and the like.

In one embodiment of the invention the copolymer component of the polymeric composition is a sole copolymer of an olefin such as ethylene, with a vinyl ester of an aliphatic carboxylic acid such as acetic acid or an acyl halide.

In another embodiment of the invention, the copolymer component of the polymeric composition is a sole ethylene-vinyl ester copolymer or a copolymer of a first vinyl ester and a second vinyl ester wherein the first vinyl ester is a vinyl ester of a lower carboxylic acid or acyl halide and the second vinyl ester is a different vinyl ester. Typically, the first vinyl ester is vinyl acetate and the second vinyl ester is a higher vinyl ester such as a fatty ester, e.g., vinyl palmitate, vinyl stearate, vinyl laurate, etc. Preferably, the first vinyl ester is vinyl acetate and the second vinyl ester is vinyl laurate wherein the ratio of vinyl acetate; vinyl laurate is about 50:50 to 90:10.

In one aspect of the invention there is provided a tubular structure manufactured from the aforementioned polymeric composition which comprises a copolymer of an olefin and a vinyl ester of a lower aliphatic carboxylic acid or a copolymer of a first vinyl ester and a second vinyl ester. The tubular structure is typically used as a hose in the automotive industry to transport fluids and gases. For example, the hose of the invention is particularly useful in the transportation of air conditioner fluids, power steering fluids, transmission oil cooler fluids, etc. where the material forming the hose exhibits the required heat tolerance, pressure resistance, impermeability resistance to the fluid being transported through the hose, etc.

In another aspect of the invention there is provided a method for manufacturing a tubular structure from the aforementioned polymeric composition which comprises a copolymer of an olefin and a vinyl ester of a lower aliphatic carboxylic acid or a copolymer of a first vinyl ester and a second vinyl ester. The tubular structure is typically used as a hose in the automotive industry to transport fluids and gases. For example, the hose of the invention is particularly useful in transportation of air conditioner fluids, power steering fluids, transmission oil cooler fluids, etc. where the material forming the hose exhibits the required heat tolerance, pressure resistance, impermeability resistance to the fluid being transported through the hose, etc.

The term “copolymer” as used herein refers to a copolymer of at least one vinyl ester of an aliphatic carboxylic acid or acyl halide. Typically, the copolymer is a vinyl ester copolymer having a vinyl ester content greater than 40% based on the total weight of the copolymer, and preferably greater than 50% based on the total weight of the copolymer. More preferably, the vinyl ester copolymers will have a vinyl ester content of about 60-90% or more. Most preferably, the vinyl ester copolymer of the invention is an ethylene-vinyl acetate copolymer.

The term “fluid” as used herein to define the substance transported through the tubular structure is intended to include gases as well as liquids.

Other ingredients or additives which serve to provide or enhance the required heat tolerance, pressure resistance, fluid permeation resistance, etc., may be included as additional components of the polymeric composition of the present invention. Such ingredients or additives include: process aids, fillers, plasticizers, metal oxides and/or hydroxides, peroxides, coagents, antioxidants, and other ingredients which are customarily added to polymeric materials to provide a desired purpose.

### DETAILED DESCRIPTION OF THE INVENTION

In accordance with a first embodiment of the invention, a polymeric composition comprising a copolymer of an olefin and a vinyl ester of an aliphatic carboxylic acid or acyl halide is described. Typically, the olefin-vinyl ester is an ethylene-vinyl ester of a C₂-C₆ carboxylic acid, e.g., ethylene-vinyl acetate copolymer. The ethylene-vinyl acetate copolymers useful in the present invention includes those having a high vinyl acetate content and good fluid resistance.

In accordance with a second embodiment of the invention, a polymeric composition comprising a copolymer of a first vinyl ester and a second vinyl ester is described. The first vinyl ester is typically a vinyl ester of a C₂-C₆ carboxylic acid or acyl halide, such as vinyl acetate, and the second vinyl ester is a different vinyl ester such as a fatty ester, e.g., vinyl palmitate, vinyl stearate, vinyl laurate, etc.

Ethylene-vinyl acetate copolymers are commercially available from a number of manufacturers including DuPont, Millennium Petrochemicals, Nova-Borealis Compounds LLC, AT Plastics Inc., Exxon, ATO Chem., Bayer AG, and others. Suitable ethylene-vinyl acetate copolymers have a vinyl acetate content greater than about 40%, preferably greater than about 50% and most preferably about 60 to 90% vinyl acetate. Ethylene-vinyl acetate copolymers available from Bayer AG under the name Levapren have been found to be particularly useful in the present invention.

While the vinyl ester copolymer is typically the sole polymeric component and the primary ingredient of the composition, other polymeric materials may be blended with the ethylene-vinyl acetate copolymer in amounts up to about 50% and preferably up to about 10%, e.g., about 1 to 10% based on the weight of the blend. Such polymeric materials include ethylene-propylene-diene monomer (EPDM), styrene-butadiene rubber (SBR), acrylonitrile-butadiene rubber (NBR), ethylene-propylene rubber (EPR), ethylene-propylene-hexadiene terpolymer, butyl rubber, cis-polybutadiene, cis-polyisoprene, polyurethane, polyamide, and the like, and mixtures thereof. Furthermore, additional components may be employed to provide the desired characteristics of the composition. These additional components include, for example, process aids in an amount up to about 8%; fillers in an amount of about 20 to 60%; plasticizers in an amount up to about 15%, preferably about 3 to 15%; metal oxides or hydroxides in an amount up to about 8%; peroxides in an amount of about 5%; coagents in an amount up to about 5%; and antioxidants in an amount up to about 5%. Other additives commonly used in polymeric compositions for use in preparing hoses may be added in appropriate amounts to provide their desired effect.

Suitable processing aids include stearic acid, stearates, polyethylene, amines, oils, organic esters, organic phosphate esters and the like.

Suitable fillers include materials, such as carbon black, silicon dioxide, fumed silica, precipitated silica, diatomaceous earth, magnesium carbonate, magnesium silicate, aluminum silicate titanium dioxide, talc, mica, aluminum sulfate, calcium sulfate, graphite, wollastonite, molybdenum disulfide, clay, calcium carbonate and combinations thereof.

Suitable plasticizers include materials such as hydrocarbons, glycols, aldehydes, ethers, esters, ether-esters, and the like.

Suitable metal oxides and metal hydroxides include zinc oxide, zinc hydroxide, magnesium oxide, magnesium hydroxide, calcium oxide, calcium hydroxide, aluminum hydroxide, and the like.

Suitable peroxides include 2,5-dimethyl-2,5-di(t-butylperoxy)hexyne-3; 2,5-dimethyl-2,5-di(t-butylperoxy)hexane; α,α′-bis-(t-butylperoxy)-p-diisopropylbenzene; dicumyl peroxide; di-t-butyl peroxide; 1,1-bis(t-butylperoxy)-3,3,3-trimethylcyclohexane; 2,4-dichlorobenzoyl peroxide; benzoyl peroxide; p-chlorobenzoyl peroxide; 4,4-bis(t-butylperoxy) valerate; and combinations thereof.

Suitable coagents include N,N,m Phenylenedimaleimide and other bismaleimides; triallyl cyanurate; triallyl isocyanurate; dially terephthalate; 1,2-vinyl polybutadienes; di- and tri-functional methacrylates and diacrylates; and metal ion versions of these coagents.

Suitable antioxidants include phenols, hydrocinnamates, diphenylamines, hydroquinone, hydroquinolines, mercaptobenzimidazoles, and the like.

The polymeric composition of the invention includes about 30 to 75% copolymer such as ethylene-vinyl acetate copolymer or a copolymer of vinyl acetate with vinyl laurate, or a blend of such copolymers with another polymeric material as discussed above, with about 25 to 70% additives.

In a preferred aspect of the invention, the ethylene-vinyl acetate copolymer composition comprises about 45 to 60% ethylene-vinyl acetate copolymer and about 40-55% of one or more additives, said additives comprising:
(a) about 0.8 to 2% process aid selected from the group consisting of stearic acid, stearates, polyethylene, amines, oils, organic esters, organic phosphate esters and combinations thereof;
(b) about 20 to 60% filler selected from the group consisting of carbon black, silicon dioxide, fumed silica, precipitated silica, diatomaceous earth, magnesium carbonate, magnesium silicate, aluminum silicate titanium dioxide, talc, mica, aluminum sulfate, calcium sulfate, graphite, wollastonite, molybdenum disulfide, clay, calcium carbonate and combinations thereof;
(c) about 3 to 15% plasticizer selected from the group consisting of hydrocarbons, glycols, aldehydes, ethers, esters, ether-esters and combinations thereof;
(d) about 0 to 10% metal oxides and/or hydroxides selected from the group consisting of zinc oxide, zinc hydroxide, magnesium oxide, magnesium hydroxide, calcium oxide, calcium hydroxide, aluminum hydroxide and combinations thereof;
(e) about 0.5 to 2% peroxide selected from the group consisting of 2,5-dimethyl-2,5-di(t-butylperoxy)hexyne-3; 2,5-dimethyl-2,5-di(t-butylperoxy)hexane; α,α′-bis-(t-butylperoxy)-p-diisopropylbenzene; dicumyl peroxide; di-t-butyl peroxide; 1,1-bis(t-butylperoxy)-3,3,3-trimethylcyclohexane; 2,4-dichlorobenzoyl peroxide; benzoyl peroxide; p-chlorobenzoyl peroxide; 4,4-bis(t-butylperoxy) valerate; and combinations thereof.
(f) about 0 to 5% coagent selected from the group consisting of maleimides, triallyl cyanurate, triallyl isocyanurate, diallyl terephthalate, 1,2-vinyl polybutadiene, di- and tri-functional methacrylates, diacrylates, metal ion versions thereof and combinations thereof; and
(g) about 0 to 3% antioxidant selected from the group consisting of phenols, hydrocinnamates, hydroquinones, hydroquinolines, diphenylamines, mercaptobenzimidazoles, and combinations thereof.

In a second aspect of the invention, a tubular structure comprising an ethylene-vinyl acetate copolymer composition formed from the aforementioned ethylene-vinyl acetate compositions is described. The tubular structure is useful for conveying automotive fluids in, for example, engine oil cooler, transmission oil cooler, power transmission cooler, radiator, heater, etc.

In a third aspect of the invention, the method for preparing the ethylene-vinyl acetate compositions useful in the present invention includes mixing the vinyl acetate copolymer compositions via open mill mixing or internal mixer such as a Banbury mixer.

In a fourth aspect of the invention, the preferred method for manufacturing the tubular structure of the invention is a continuous spiral production method comprising:

Providing an inner layer of a material produced in a mono-extrusion of an annular configuration;

Applying a reinforcement material to the annular extrudate in a two-layer spiral format in which one layer is applied in a clockwise direction and the other layer is applied in a counter-clockwise direction.

Applying an outer layer over the reinforcement layer in a mono-extrusion of an annular configuration.

Vulcanizing the composite tubular structure, including molded profiles, by conventional methods such as in an autoclave, a salt bath, microwave, hot air oven, infrared, etc.

The reinforcement materials include natural fibers such as cotton; synthetic fibers such as polyester, nylon, rayon, aramid, and metal wire. The reinforcement may be applied by knit or maypole type braid methods.

In still another aspect of the invention, there is described an improved tubular structure for transporting engine oil cooler fluids, transmission oil cooler fluids, power steering fluids, radiator fluids, heater fluids, and the like, wherein the tubular structure is formed from a sole olefin-vinyl ester of a C₂-C₆ aliphatic carboxylic acid or acyl halide. The olefin-vinyl ester copolymer has incorporated therein one or more additives.

The invention is illustrated in more detail by way of the following non-limiting examples.

### EXAMPLES

### Example 1

| | EXAMPLE 1 | | |
|---|---|---|---|
| | Parts per hundred of polym r (phr) | | |
| | | B | C |
| | A | Ethylene | Chlorinated |
| Polymer type | EVM | Acrylate | Polyethylene |
| Levapren ® 600 HV | 100 | Proprietary | Proprietary |
| | | Formula | Formula |
| Stearic Acid | 1 | | |
| Mixed Styrenated Phenylene | 2 | | |
| Diamines | | | |
| N650 Carbon Black | 60 | | |
| Ether/Ester Plasticizer | 10 | | |
| 1-Octadecanamine | 1 | | |
| Triallyl Cyanurate, 72% Dispersion | 3 | | |
| Di(t-butyleperoxy)diisopropyl | 6 | | |
| benzene; 40% dispersion | | | |
| Cured 30 minutes @ 175° C. | | | |
| Original Properties | | | |
| Tensile Strength; psi | 1863 | 1837 | 1765 |
| Elongation % | 250 | 286 | 265 |
| 100% Modulus; psi | 693 | 881 | 892 |
| Hardness; Shore A | 73 | 77 | 86 |
| Compression Set, 70 h. @ 175° C. | 33 | 48 | 78 |
| After 70 hours @ 175° C. in Air | | | |
| Tensile Strength; psi | 1837 | 2309 | 1752 |
| Elongation % | 275 | 202 | 140 |
| 100% Modulus; psi | 833 | 1307 | 1493 |
| Hardness; Shore A | 83 | 88 | 93 |

After 70 hours @ 175° C. in Chrysler MS9602 Automatic
Transmission Fluid

| | | | |
|---|---|---|---|
| Tensile Strength; psi | 1654 | 2150 | 1556 |
| Elongation % | 314 | 199 | 119 |
| 100% Modulus; psi | 477 | 1103 | 1322 |
| Hardness; Shore A | 55 | 71 | 77 |
| Volume Change; % | 23 | 11 | 14 |

After 336 hours @ 175° C. in Dexron III ® Automatic
Transmission Fluid

| | | | |
|---|---|---|---|
| Tensile Strength; psi | 1172 | 1612 | Too Brittle |
| | | | to Test |
| Elongation % | 222 | 119 | |
| 100% Modulus; psi | 383 | 1281 | |
| Hardness; Shore A | 51 | 68 | |
| Volume Change; % | 34 | 19 | |

Levapren is an ethylene-vinyl acetate copolymer available from Bayer Corporation
Dexron is a trademark of General Motors Corporation

### Example 2

| | EXAMPLE 2 | | |
|---|---|---|---|
| | Parts per hundred of polymer | | |
| | (phr) | | |
| | D | E | F |
| Levapren ® 500 HV | 100 | | |
| Levapren ® 600 HV | | 100 | |
| Levapren ® KA8815 | | | 100 |
| Stearic Acid | 1 | 1 | 1 |
| Mixed Styrenated Phenylene Diamines | 2 | 2 | 2 |
| N650 Carbon Black | 60 | 60 | 60 |
| Ether/Ester Plasticizer | 10 | 10 | 10 |
| 1-Octadecanamine | 1 | 1 | 1 |
| Triallyl Cyanurate, 72% Dispersion | 3 | 3 | 3 |
| Di(t-butyleperoxy)diisopropyl benzene; | 6 | 6 | 6 |
| 40% Dispersion | | | |
| Cured 60 minutes @ 160° C. | | | |
| Original Properties | | | |
| Tensile Strength; psi | 1841 | 1804 | 1790 |
| Elongation % | 270 | 319 | 253 |
| 100% Modulus; psi | 230 | 381 | 460 |
| Hardness; Shore A | 64 | 62 | 59 |
| Compression Set, 70 h. @ 175° C. | 33 32 | 29 | |
| After 70 hours @ 175° C. in Air | | | |
| Tensile Strength; psi | 1755 | 1653 | 1622 |
| Elongation % | 251 | 270 | 241 |
| 100% Modulus; psi | 515 | 547 | 541 |
| Hardness; Shore A | 69 | 72 | 59 |

After 70 hours @ 175° C. in Chrysler MS9602 Automatic
Transmission Fluid

| | | | |
|---|---|---|---|
| Tensile Strength; psi | 1506 | 1650 | 1587 |
| Elongation % | 250 | 317 | 253 |
| 100% Modulus; psi | 368 | 421 | 430 |
| Hardness; Shore A | 42 | 52 | 50 |
| Volume Change; % | 36 | 18 | 16 |

After 70 hours @ 150° C. in Dexron III ® Automatic
Transmission Fluid

| | | | |
|---|---|---|---|
| Tensile Strength; psi | 1276 | 1512 | 1444 |
| Elongation % | 226 | 283 | 236 |
| 100% Modulus; psi | 389 | 423 | 352 |
| Hardness; Shore A | −25 | 45 | 45 |
| Volume Change; % | 55 | 30 | 26 |

Levapren is an ethylene-vinyl acetate copolymer available from Bayer Corporation
Dexron is a trademark of General Motors Corporation

### Example 3

| | G | H | I | J | K | L | M |
|---|---|---|---|---|---|---|---|
| Parts per hundred f polymer (phr) | | | | | | | |
| Levapren ® 600 HV | 95 | 100 | 100 | 100 | 100 | 100 | 100 |
| Nordel ® IP 4640 | 5 | | | | | | |
| Stearic Acid | 1 | 1 | 1 | 1 | 1 | 1 | 1 |
| Magnesium Oxide | | | 10 | 20 | 5 | 5 | 5 |
| N650 Carbon Black | 60 | 60 | 70 | 50 | 50 | 60 | 60 |
| Silicon Dioxide | | | 5 | 5 | 5 | 5 | 5 |
| Ether/Ester Plasticizer | 10 | 10 | | 5 | | | 5 |
| Trioctyl Trimellitate | | | 7.5 | 5 | 10 | 10 | 5 |
| Adipate Plasticizer | | | 2.5 | | | | |
| 1-Octadecanamine | 1 | 1 | 1 | 1 | 1 | 1 | 1 |
| Poly(oxy-1,2-ethanediyl),alpha-octadocyl-omega-hydroxy,- | | | 1 | | | | |
| phosphate | | | | | | | |
| Triallyl Cyanurate, 72% Dispersion | 3 | 3 | 1 | 3 | 3 | 3 | 3 |
| High Vinyl Homopolymer of Butadiene; 70% Dispersion | | | | | | | |
| N,N′-m-Phenylene Dimaleimide | | | 1 | | | | |
| Dicumyl Peroxide; 60% Dispersion | 6.4 | 5 | 4 | 4 | 4 | 4 | 4 |
| Mixed Styrenated Phenylene Diamines; 70% Dispersion | 2 | 2 | | 2 | 2 | | 2 |
| 4,4′-Di(methylbenzyl)diphenylamine | | | 2 | | | | |
| Zinc 2,mercaptotoluimidazole | | | | | | 2 | |
| Tetrakis[methylene(3,5-di-tert-butyl-4- | | | | | | 2 | |
| hydroxyhydrocinnamate)]methane | | | | | | | |
| Cured 30 minutes @ 175° C. Original Properties | | | | | | | |
| Tensile Strength; psi | 1575 | 1248 | 1876 | 1861 | 1993 | 1942 | 1676 |
| Elongation % | 371 | 384 | 2601 | 284 | 232 | 222 | 229 |
| 100% Modulus; psi | 337 | 349 | 827 | 713 | 764 | 864 | 704 |
| Hardness; Shore A | 64 | 65 | 76 | 72 | 70 | 75 | 74 |
| Compression Set, 70 h. @ 175° C. | 40 | 30 | 48 | 70 | 27 | 35 | 37 |
| After 70 hours @ 175° C. in Air | | | | | | | |
| Tensile Strength; psi | 1411 | 1228 | | | | | |
| Elongation % | 329 | 357 | | | | | |
| 100% Modulus; psi | 542 | 540 | | | | | |
| Hardness; Shore A | 75 | 78 | | | | | |
| After 168 hours @ 175° C. in Air | | | | | | | |
| Tensile Strength; psi | | | 1517 | 1754 | 1857 | 1814 | 1709 |
| Elongation % | | | 204 | 215 | 181 | 113 | 173 |
| 100% Modulus; psi | | | 1345 | 1288 | 1180 | 1702 | 1284 |
| Hardness; Shore A | | | 92 | 88 | 84 | 90 | 89 |
| After 70 hours @ 175° C. | | | | | | | |
| in Chrysler MS9602 Automatic Transmission Fluid | | | | | | | |
| Tensile Strength; psi | 1156 | 1053 | 1617 | | | | |
| Elongation % | 388 | 295 | 261 | | | | |
| 100% Modulus; psi | 241 | 300 | 592 | | | | |
| Hardness; Shore A | 46 | 47 | 55 | | | | |
| Volume Change; % | 38 | 33 | 29 | | | | |
| After 70 hours @ 175° C. | | | | | | | |
| in Dexron III ® Automatic Transmission Fluid | | | | | | | |
| Tensile Strength; psi | | | | | 1436 | 1406 | 1284 |
| Elongation % | | | | | 193 | 234 | 218 |
| 100% Modulus; psi | | | | | 600 | 506 | 509 |
| Hardness; Shore A | | | | | 48 | 47 | 50 |
| Volume Change; % | | | | | 42 | 43 | 45 |

Levapren is an ethylene-vinyl acetate copolymer available from Bayer Corporation
Nordel is an ethylene-propylene-hexadiene terpolymer available from DuPont Dow Elastomers
Dexron is a trademark of General Motors Corporation

While preferred embodiments of the invention have been exemplified and described in detail in the above examples and specification, it will be apparent to those skilled in the art that the invention may be modified. Therefore, the foregoing examples and description are to be considered exemplary rather than limiting and are not to be limited thereto.

1. A vulcanized automotive fluid-conveying tubular structure comprising a heat tolerant, pressure resistant, hydrocarbon fluid impermeable composition containing at least one vinyl ester copolymer, wherein said vinyl ester copolymer contains greater than 40% vinyl ester based on the weight of said copolymer.

2. The tubular structure of claim 1 wherein said at least one vinyl ester copolymer contains about 60 ti 90% vinyl ester based on the weight of said copolymer.

3. The tubular structure of claim 2 wherein said at least one vinyl ester copolymer is an olefin-vinyl ester copolymer.

4. The tubular structure of claim 3 wherein said copolymer is an ethylene-vinyl acetate copolymer.

5. The tubular structure of claim 4 wherein said copolymer is an ethylene-vinyl acetate copolymer.

6. The tubular structure of claim 4 wherein said composition comprises about 30 to 75% ethylene-vinyl acetate copolymer and about 25 to 70% one or more additives.

7. The tubular structure of claim 6 wherein said one or more additives are selected from the group consisting of process aids, fillers, plasticizers, metal oxides, metal hydroxides, peroxides, coagents, antioxidants and combinations thereof.

8. The tubular structure of claim 7 wherein said composition comprises about 45 to 60% ethylene-vinyl acetate copolymer and about 40 to 55% of one or more additives, said additives comprising;
(a) about 0.8 to 2% process aid selected from the group consisting of stearic acid, stearates, polyethylene, amines, oils, organic esters, organic phosphate esters and combinations thereof;
(b) about 20 to 60% filler selected from the group consisting of carbon black, silicon dioxide, fumed silica, precipitated silica, diatomaceous earth, magnesium carbonate, magnesium silicate, aluminum silicate, titanium dioxide, talc, mica, aluminum sulfate, calcium sulfate, graphite, wollastonite, molybdenum disulfide, clay, calcium carbonate and combinations thereof;
(c) about 3 to 15% plasticizer selected from the group consisting of hydrocarbons, glycols, aldehydes, ethers, esters, ether-esters and combinations thereof;
(d) about 0 to 10% metal oxides and/or hydroxides selected from the group consisting of zinc oxide, zinc hydroxide, magnesium oxide, magnesium hydroxide, calcium oxide, calcium hydroxide, aluminum hydroxide and combinations thereof;
(e) about 0.5 to 2% peroxide selected from the group consisting of 2,5-dimethyl-2,5-di(t-butylperoxy)hexyne-3; 2,5-dimethyl-2,5-di(t-butylperoxy)hexane; α,α′-bis-(t-butylperoxy)-p-diisopropylbenzene; dicumyl peroxide; di-t-butyl peroxide; 1,1-bis(t-butylperoxy)-3,3,3-trimethylcyclohexane; 2,4-dichlorobenzoyl peroxide; benzoyl peroxide; p-chlorobenzoyl peroxide; 4,4-bis(t-butylperoxy) valerate; and combinations thereof;
(f) about 0 to 5% coagent selected from the group consisting of maleimides, triallyl cyanurate, triallyl isocyanurate, diallyl terephthalate, 1,2-vinyl polybutadiene, di- and tri-functional methacrylates, diacrylates, metal ion versions thereof and combinations thereof; and
(g) about 0 to 0.3% antioxidant selected from the group consisting of phenols, hydrocinnamates, hydroquinones, hydroquinolines, diphenylamines, mercaptobenzimidazoles, and combinations thereof.

9. The tubular structure of claim 1 wherein said composition further comprises a polymeric material selected from the group consisting of ethylene-propylene-diene terpolymer (EPDM), styrene-butadiene rubber (SBR), acrylonitrile-butadiene rubber (NBR), ethylene-propylene rubber (EPR), butyl rubber, cis-polybutadiene, cis-polyisoprene, polyurethane, polyamide, and mixtures thereof.

10. A vulcanized automotive fluid-conveying tubular structure comprising an ethylene-vinyl acetate copolymer having a vinyl acetate content of about 60 to 90% based on the weight of said copolymer, said tubular structure comprising about 45 to 60% ethylene-vinyl acetate copolymer and about 40 to 55% of one or more additives, said additives comprising:
(a) about 0.8 to 2% process aid selected from the group consisting of stearic acid, stearates, polyethylene, amines, oils, organic esters, organic phosphate esters and combinations thereof;
(b) about 20 to 60% filler selected from the group consisting of carbon black, silicon dioxide, fumed silica, precipitated silica, diatomaceous earth, magnesium carbonate, magnesium silicate, aluminum silicate, titanium dioxide, talc, mica, aluminum sulfate, calcium sulfate, graphite, wollastonite, molybdenum disulfide, clay, calcium carbonate and combinations thereof;
(c) about 3 to 15% plasticizer selected from the group consisting of hydrocarbons, glycols, aldehydes, ethers, esters, ether-esters and combinations thereof;
(d) about 0 to 10% metal oxides and/or hydroxides selected from the group consisting of zinc oxide, zinc hydroxide, magnesium oxide, magnesium hydroxide, calcium oxide, calcium hydroxide, aluminum hydroxide and combinations thereof;
(e) about 0.5 to 2% peroxide selected from the group consisting of 2,5-dimethyl-2,5-di(t-butylperoxy)hexyne-3; 2,5-dimethyl-2,5-di(t-butylperoxy)hexane; α,α′-bis-(t-butylperoxy)-p-diisopropylbenzene; dicumyl peroxide; di-t-butyl peroxide; 1,1-bis(t-butylperoxy)-3,3,3-trimethylcyclohexane; 2,4-dichlorobenzoyl peroxide; benzoyl peroxide; p-chlorobenzoyl peroxide; 4,4-bis(t-butylperoxy) valerate; and combinations thereof;
(f) about 0 to 5% coagent selected from the group consisting of maleimides, triallyl cyanurate, triallyl isocyanurate, diallyl terephthalate, 1,2-vinyl polybutadiene, di- and tri-functional methacrylates, diacrylates, metal ion versions thereof and combinations thereof, and
(g) about 0 to 0.3% antioxidant selected from the group consisting of phenols, hydrocinnamates, hydroquinones, hydroquinolines, diphenylamines, mercaptobenzimidazoles, and combinations thereof.

11. A method for preparing an automotive fluid-conveying tubular structure, wherein said tubular structure comprises a heat tolerant, pressure resistant, hydrocarbon fluid impermeable copolymer composition comprising at least one vinyl ester, said method comprising: providing a copolymer comprising at least one vinyl ester wherein said copolymer contains greater than 40% vinyl ester based on the weight of said copolymer;
incorporating into said copolymer, one or more additives selected from the group consisting of process aids, fillers, plasticizers, metal oxides, metal hydroxides, peroxides, coagents, antioxidants and combinations thereof;
forming a tubular structure of said copolymer containing said additives; and
vulcanizing said tubular structure.

12. The method of claim 11 wherein said at least one vinyl ester contains about 60 to 90% vinyl ester based on the weight of said copolymer.

13. The method of claim 12 wherein said at least one vinyl ester copolymer is an olefin-vinyl ester copolymer.

14. The method of claim 13 wherein said copolymer is an ethylene-vinyl acetate copolymer.

15. The method of claim 14 wherein said copolymer is an ethylene-vinyl acetate copolymer.

16. The method of claim 13 wherein said composition comprises about 30 to 75% of said ethylene-vinyl acetate copolymer and about 25 to 70% a of one or more additives.

17. The method of claim 16 wherein said one or more additives are selected from the group consisting of process aids, fillers, plasticizers, metal oxides, metal hydroxides, peroxides, coagents, antioxidants and combinations thereof.

18. The method of claim 16 wherein said composition comprises about 45 to 60% ethylene-vinyl acetate copolymer and about 40 to 55% of one or more additives comprising:
(a) about 0.8 to 2% process aid selected from the group consisting of stearic acid, stearates, polyethylene, amines, oils, organic esters, organic phosphate esters and combinations thereof;
(b) about 20 to 60% filler selected from the group consisting of carbon black, silicon dioxide, fumed silica, precipitated silica, diatomaceous earth, magnesium carbonate, magnesium silicate, aluminum silicate, titanium dioxide, talc, mica, aluminum sulfate, calcium sulfate, graphite, wollastonite, molybdenum disulfide, clay, calcium carbonate and combinations thereof:
(c) about 3 to 15% plasticizer selected from the group consisting of hydrocarbons, glycols, aldehydes, esters, esters, ether-esters and combinations thereof;
(d) about 0 to 10% metal oxides and/or hydroxides selected from the group consisting of zinc oxide, zinc hydroxide, magnesium oxide, magnesium hydroxide, calcium oxide, calcium hydroxide, aluminum hydroxide and combinations thereof;
(e) about 0.5 to 2% peroxide selected from the group consisting of 2,5-dimethyl-2,5-di(t-butylperoxy)hexyne-3; 2,5-dimethyl-2,5-di(t-butylperoxy)hexane; dicumyl peroxide; α,α′-bis-(t-butylperoxy)-p-diisopropylbenzene; di-t-butyl peroxide; 1,1-bis(t-butylperoxy)-3,3,3-trimethylcyclohexane; 2,4-dichlorobenzoyl peroxide; benzoyl peroxide; p-chlorobenzoyl peroxide; and combinations thereof:
(f) about 0 to 5% coagent selected from the group consisting of maleimides, triallyl cyanurate, triallyl isocyanurate, diallyl terephthalate, 1,2-vinyl polybutadiene, di- and tri-functional methacrylates and diacrylates, and combinations thereof; and
(g) about 0 to 0.3% antioxidant selected from the group consisting of Phenols, hydrocinnamates, hydroquinones, hydroquinolines, diphenylamines, mercaptobenzimidazoles, and combinations thereof.

19. The method of claim 11 further comprising adding a polymeric material to said composition wherein said polymeric material is selected from the group consisting of ethylene-propylene-diene terpolymer (EPDM), styrene-butadiene rubber (SBR), acrylonitile-butadiene rubber (NBR), ethylene-propylene rubber (EPR), butyl rubber, cis-polybutadiene, cis-polyisoprene, polyurethane, polyamide, and mixtures thereof.

20. In an automotive fluid-conveying tubular structure for conveying fluids in an automotive engine cooler, transmission oil cooler, power transmission cooler, radiator or heater, the improvement comprising employing as the tubular structure a vulcanized heat tolerant, pressure resistant, hydrocarbon fluid impermeable composition, wherein said composition comprises: an ethylene-vinyl acetate copolymer matrix having greater than about 40% vinyl acetate based upon the weight of said copolymer, said vinyl acetate copolymer matrix having incorporated therein, one or more additives selected from the group consisting of process aids, fillers, plasticizers, metal oxides, meta hydroxides, peroxides, coagents, antioxidants and combinations thereof.

21. The tubular structure of claim 20 wherein said tubular structure is a radiator hose.

22. The tubular structure of claim 29 wherein said tabular structure is a heater hose.
